(19) United States
(12) Patent Application Publication
(10) Pub. No.: US 2007/0198788 A1
(43) Pub. Date: Aug. 23, 2007

(54) MEMORY ACCESS METHODS

(75) Inventors: Wen-Hung Hsien, Taichung (TW); Ching-Jung Tsai, Taichung (TW); Shih-Yi Lin, Taichung (TW); Chien-Hung Chen, Taichung (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ASIA OPTICAL CO., INC., Taichung (TW)

(21) Appl. No.: 11/612,186

(22) Filed: Dec. 18, 2006

(30) Foreign Application Priority Data
Feb. 21, 2006 (TW) 95105731

(51) Int. Cl. G06F 13/00

(52) U.S. Cl. 711/159

(57) ABSTRACT

A memory access method is implemented in an electronic device comprising a main memory, a storage unit with a first bank and a second bank. Upon booting or resetting an electronic device, a first data set in the first bank is loaded to the main memory to be a second data set. When a first record in the second data set is modified, a corresponding record is stored to a specific address in the first bank. If the first bank does not have enough memory capacity, the corresponding record is stored in the second bank, and the first bank as well as the first record therein is erased after the storage operation. Otherwise, the first band, if having enough capacity, continues to store corresponding records.

### BACKGROUND OF THE INVENTION

1. Field of the Invention

The present invention relates to computer techniques, and more particularly to access methods.

2. Description of the Related Art

Most portable electronic devices, such as digital cameras, mobile phones, personal digital assistants (PDAs), global positioning systems (GPSs), and media players (such as players for files of Moving Picture Experts Group 1 Layer 3, known as MP3 files) comprise storage components, typically flash memories as a kind of non-volatile memories.

As non-volatile memory keeps data even when a device has no power, the access speed thereof is inferior to that of volatile memory, such as dynamic random access memory (DRAM). Thus non-volatile memories are typically utilized as mass storage devices. If high speed calculation is desired, data must be copied to a random access memory (RAM).

For example, a digital camera equipped with flash memory for mass storage loads settings and predetermined programs to a main memory when booting. Data in the main memory may be modified during operation of the digital camera and written into the remaining memory capacity of the flash memory before shutdown. In practice, flash memory without enough capacity is erased before storing the data. If data storage is interrupted by a power failure, the settings may be lost.

Additionally, a typical portable electronic device capable of memory access erases its flash memory and stores a full version backup of the settings from its main memory thereto even if only one record is modified. This not only consumes storage capacity but also reduces the life of frequently-erased flash memory.

### BRIEF SUMMARY OF THE INVENTION

Memory access methods are provided.

Accordingly, an exemplary embodiment of a memory access method is implemented in an electronic device comprising a main memory, a storage unit with a first bank and a second bank. When the electronic device boots, a first data set in the first bank is loaded to the main memory to be a second data set. When a first record in the second data set is modified, a corresponding record is stored to a specific address in the first bank. The first corresponding record follows the first data set and comprises an address and a new value of the first record.

If the first bank does not have enough memory capacity, the second data set is stored in the second bank, and the first bank is erased after storage. Otherwise, the first band, if having enough capacity, continues to store corresponding records.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of the configuration of an electronic device;

FIG. 2 is flowchart of an exemplary embodiment of a memory access method;

FIG. 3 is a schematic view showing the electronic device;

FIG. 4 is another schematic view showing the electronic device; and

FIG. 5 is a flowchart of a setting loading process.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

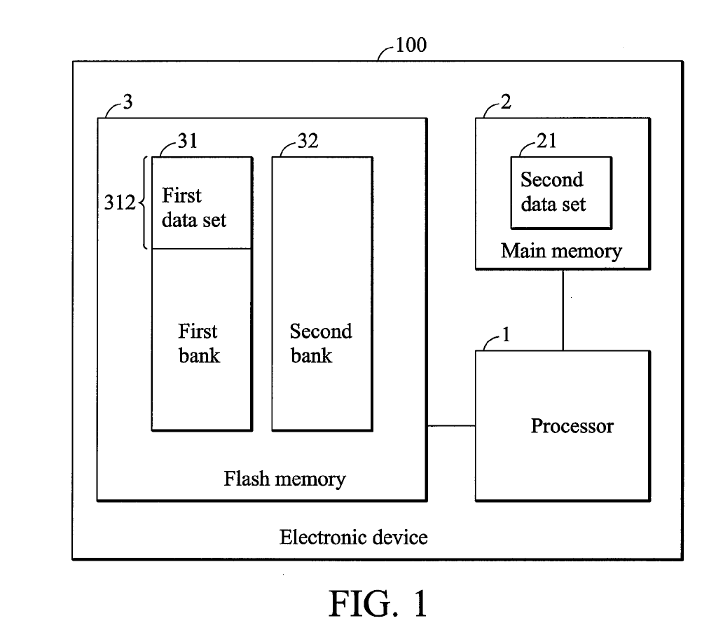

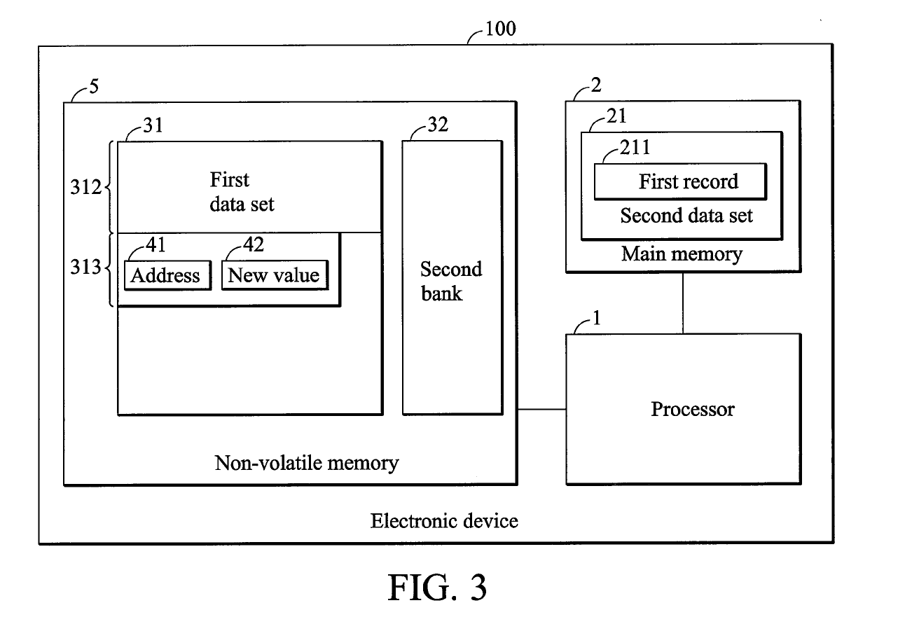

In electronic device 100 of FIG. 1, processor 1 is coupled to main memory 2 and storage unit 3. Electronic device 100 may comprise a digital camera, a mobile phone, a PDA, a GPS receiver, a media player (such as a MP3 player), a combination thereof, or another portable electronic device capable of memory access. Main memory 2 may comprise windows random-access memory (WRAM), video random-access memory (VRAM), or another RAM. Storage unit 3 may be implemented by non-volatile memory 5 in FIG. 3.

Storage unit 3 comprises first bank 31 storing first data set 312, i.e. settings of electronic device 100. The settings may comprise settings of display brightness, contrast, the desktop image, background music, programs and others.

The sizes of first bank 31 and second bank 32 are respectively greater than the size of the settings and not smaller than a block, the basic unit for erasing storage unit 3. First bank 31 and second bank 32 may be located in the same memory or different memory.

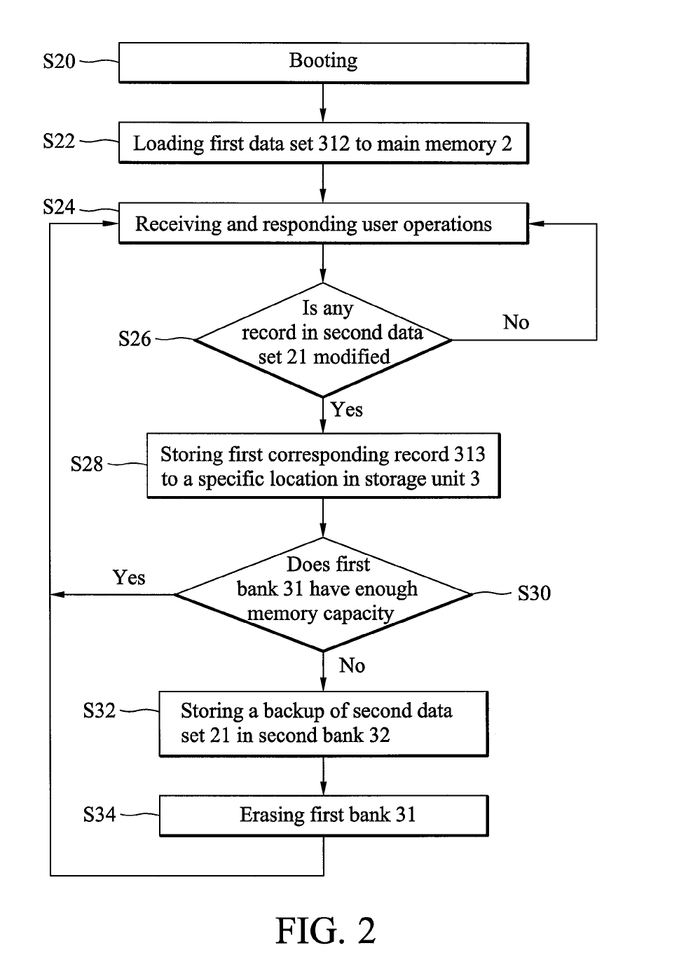

With reference to FIG. 1 and FIG. 2, electronic device 100 implements an exemplary embodiment of a memory access method.

When electronic device 100 boots (step S20), processor 1 loads first data set 312 from first bank 31 to main memory 2 to be second data set 21 (step S22). Processor 1 receives and responds user operations (step S24). Second data set 21 in main memory 2 may be modified during the operations. Processor 1 determines if any record in second data set 21 is modified (step S26).

When first record 211 in second data set 21 is modified, processor 1 stores first corresponding record 313 to a specific location in storage unit 3 out of first data set 312 (step S28).

Storage unit 3 is implemented by non-volatile memory 5 as shown in FIG. 3. The specific location where first corresponding record 313 is stored is adjacent to first data set 312, and first corresponding record 313 comprises address 41 and new value 42 of first record 211. Address 41 indicating the location of first record 211 in main memory 2. First data set 312 and first corresponding record 313 are stored in first bank 31 of non-volatile memory 5.

When storing first corresponding record 313, processor 1 determines if first bank 31 has enough memory capacity (step S30). If so, storage of first corresponding record 313 is then successively complete, and step S24 is repeated.

When a second record in second data set 21 is modified, processor 1 stores a second corresponding record adjacent to first corresponding record 313, wherein the second corresponding record comprises an address and a new value of the second record.

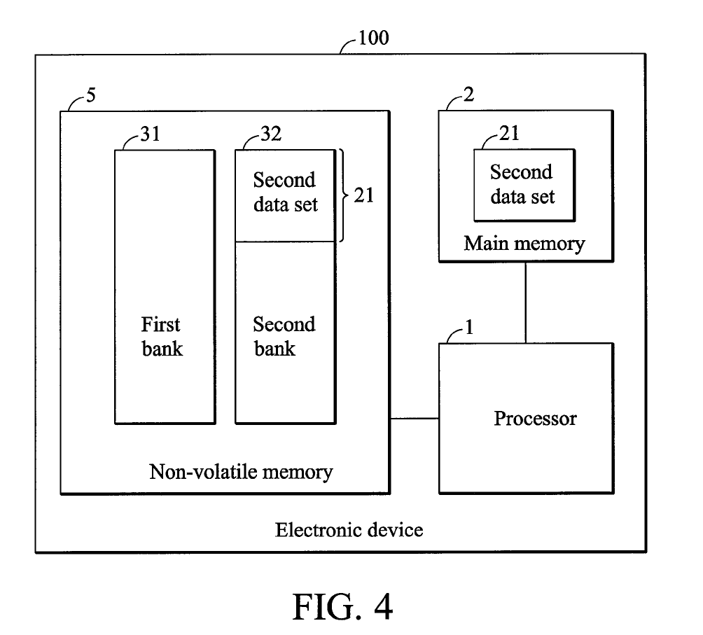

When first bank 31 does not have enough memory capacity, processor 1 stores a backup of second data set 21 in second bank 32 of non-volatile memory 5 (step S32) and erases first bank 31 as well as data therein (step S34). FIG. 4 shows non-volatile memory 5 with erased first bank 31. Step S24 is repeated. Second bank 32 may be initialized at or before step S32.

Since first record 211 in second data set 21 has been modified, it is not necessary to store an additional record corresponding to first record 211 in second bank 32. When a third record in second data set 21 is modified, processor 1 stores a third corresponding record in second bank 32 and adjacent to the backup of second data set 21. Note that, in another embodiment, data in first bank 31 (comprising first data set 312 and first corresponding record 313) may be duplicated and stored in second bank 32, and first bank 31 is subsequently erased.

New settings (second data set 21) of electronic device 100 are stored before original settings (first data set 312) are cleared. Thus, even though settings storing process is interrupted by power failure, processor 1 may determine that the new settings are not complete and accordingly loads the original settings.

To determine whether the new settings are whole, for example, processor 1 writes a corresponding status tag in second bank 32 when storage of second data set 21 is complete. Processor 1 may determine whether the new settings are complete based on existence of the tag.

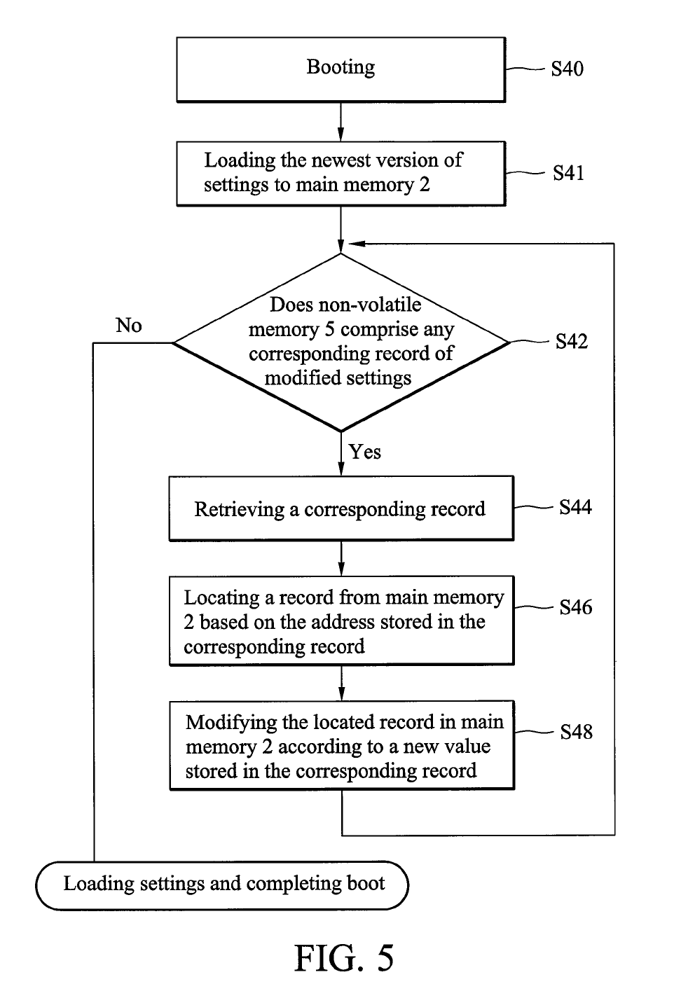

With reference to FIG. 5, when electronic device 100 reboots after a power failure (step S40), processor 1 selects a version of the settings with the last backup time and loads the version to main memory 2 (step S41). When first data set 312 exists in first bank 31, processor 1 loads first data set 312 to main memory 2 to be second data set 21. Otherwise, when the first bank has been erased or comprises a version of settings which is not complete, processor 1 loads second data set 21 from second bank 32 to main memory 2 when electronic device 100 reboots.

Processor 1 determines if non-volatile memory 5 comprises any corresponding record of modified settings (step S42). If non-volatile memory 5 does not comprise any corresponding record of modified settings, the settings loading process of the boot is complete.

If non-volatile memory 5 comprises a corresponding record of modified settings, processor 1 selects the corresponding record, such as first corresponding record 313 (step S44). Processor 1 locates first record 211 from main memory 2 based on address 41 stored in first corresponding record 313 (step S46) and modifies first record 211 in main memory 2 according to new value 42 in first corresponding record 313 (step S48). Step S42 is repeated.

When a setting of electronic device 100 is changed, a corresponding record thereof, not all settings, which comprises the address and a new value of the changed setting is immediately stored in non-volatile memory 5. When a bank of a flash memory does not have enough capacity for storing device settings from a main memory, the settings are stored to another bank before erasing the fully loaded bank. Thus, the erased bank may be utilized for storing future versions of settings.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A memory access method, implemented in an electronic device comprising a main memory, a storage unit with a first bank and a second bank, comprising:
when the electronic device boots, loading a first data set in the first bank to the main memory to be a second data set;
when a first record in the second data set is modified, and the first bank has enough memory capacity, storing a first corresponding record to a specific location in the first bank; and
if the first bank does not have enough memory capacity, storing the second data set in the second bank, and subsequently erasing the first bank.

2. The method as claimed in claim 1, wherein the first corresponding record comprises an address and a new value of the first record.

3. The method as claimed in claim 2, wherein the address indicating the location of the first record in the main memory.

4. The method as claimed in claim 3, comprising:
the electronic device, when rebooting, loads the first data set to the main memory to be the second data set;
locating the first record in the main memory based on the address included in the first corresponding record; and
modifying the first record based on the new value in the first corresponding record.

5. The method as claimed in claim 1, wherein the specific location to which the first corresponding record is stored is adjacent to the first data set.

6. The method as claimed in claim 1, wherein, when a second record in the second data set is modified, a second corresponding record is stored adjacent to the first corresponding record, and the second corresponding record comprises an address and a new value of the second record.

7. The method as claimed in claim 1, wherein the first data set comprises settings of the electronic device.

8. The method as claimed in claim 1, wherein the electronic device comprises a portable electronic device with a storage unit and capable of accessing the storage unit.

9. The method as claimed in claim 8, wherein the electronic device comprises a digital camera.

10. The method as claimed in claim 1, wherein the storage unit comprises a non-volatile memory.
